(19) United States
(12) Patent Application Publication
(10) Pub. No.: US 2009/0128437 A1
(43) Pub. Date: May 21, 2009

(54) Antenna

(76) Inventors: Kensaku Sonoda, Aichi (JP); Rikiya Kan, Saitama (JP); Kenichi Shirota, Saitama (JP); Kiyoshi Koike, Niigata (JP)

Correspondence Address: JORDAN AND HAMBURG LLP, 122 EAST 42ND STREET, SUITE 4000, NEW YORK, NY, 10168, US

(21) Appl. No.: 12/227,743

(22) PCT Filed: May 26, 2008
(86) PCT No.: PCT/JP2008/060104

§ 371 Date: Jan. 22, 2009

(30) Foreign Application Priority Data
May 29, 2007 (JP) 2007 141669

(51) Int. Cl. H01Q 7/08

(52) U.S. Cl. 343/788

(57) ABSTRACT

There is provided an antenna whose outside shape can be miniaturized while maintaining a gain at a desired level with respect to a radio wave of a wide frequency range. The antenna is configured by using a core of a laminate structure. The core is a plate of a rectangular outside shape, configured to have a laminate structure including each of first, second and third resin layers. The first resin layer has magnetic powder mixed therein and formed as a middle layer, and the second resin layer and the third resin layer made of resin only without magnetic powder mixed therein are formed to sandwich the first resin layer therebetween. In the core of the laminate structure, it is preferable to use a polymer resin for each of the resin layers, and to use soft ferrite powder as the magnetic powder.

### BACKGROUND OF THE INVENTION

The present invention relates to a structure of a small antenna and, more particularly, to an antenna having high gain and formed in a size allowing it to be equipped in mobile terminal device.

In recent years, there has appeared a mobile terminal device, which singly receives radio waves of wide frequencies including FM radio broadcasting and television broadcasting from VHF band to UHF band, or the wide frequency range further including mobile radio communications in a high frequencies of UHF band, for example. In order to receive the radio waves of the wide frequencies, a wideband antenna capable of handling each of signal frequencies is naturally needed. However, a wavelength of a radio wave in the VHF band is several meters, whereas a wavelength of a radio wave in the UHF band is several tens centimeters. Therefore, in the case where antennas capable of singly coping with the two frequency bands of the UHF and VHF are fabricated to be equipped in a portable terminal with a limited capacity, there arises a problem to fabricate a wideband antenna of a small size.

For example, if the outside shape of the antenna is simply miniaturized, a gain, transmitting/receiving efficiency, or sensitivity is decreased. Therefore, in order to miniaturize the antenna while maintaining the required gain, transmitting/receiving efficiency, or sensitivity, it is needed to use core made of dielectrics having somewhat high permittivity or a core made of soft magnet formed using a resin, in which soft magnetic powder of somewhat high magnetic permeability is mixed, and then, to wind a conductor around the core or to form a conductor pattern helically winding around the core. A basic structure of such an antenna is disclosed in Japanese Patent Application Laid-open Nos. Hei 11-234029, 2000-278020, or 2005-86418.

### SUMMARY OF THE INVENTION

By using a core obtained by mixing magnetic powder into a resin having characteristics as a dielectric, an antenna of small size and high gain can be achieved due to the interaction of a permittivity (∈) of the resin and a magnetic permeability (μ) of the magnetic powder. Here, by increasing the amount of magnetic powder mixed into the resin, the magnetic permeability (μ) of the core becomes higher, and thus an antenna may be formed in still smaller size. Also, by using magnetic powder of excellent magnetic characteristics, the magnetic permeability of the core becomes higher similar to the case where the mixture amount of magnetic powder is increased, and thus an antenna may be formed in still smaller size. However, in the case where the mixture amount of magnetic powder is actually increased, there arises a problem of a phenomenon of a decrease in gain in a high frequency band, which seems to be caused by a mitigation loss of a magnetic material, and therefore, it is difficult to achieve an antenna having small size and high gain.

In view of this, an object of the present invention is to provide an antenna whose outside shape can be miniaturized while maintaining a gain at a desired level with respect to a radio wave of a wide frequency range.

According to the present invention, the above-described problems are solved by using a core of a laminate structure, in which a resin layer having magnetic powder mixed therein is arranged inside whereas a resin layer having no magnetic powder mixed therein is arranged outside.

Specifically, an antenna according to the present invention is an antenna with a resin core having magnetic powder mixed therein, a coil conductor helically winding around the center portion of the core, and various terminals for electrically connecting the coil conductor to an outside circuit, including: a first resin layer having the core of a predetermined magnetic characteristics owing to the mixture of the magnetic powder; and a second resin layer and a third resin layer having no magnetic powder mixed therein and formed to sandwich the first resin layer therebetween from the top side and the bottom side.

Moreover, an antenna according to the present invention capable of further increasing gain depending on a current distribution pattern appearing on a coil conductor of the antenna, is an antenna with a resin core, a coil conductor helically winding around the center portion of the core, and various terminals for electrically connecting the coil conductor to an outside circuit, wherein the core has at least a first core portion and a second core portion formed between a first end and a second end, the first core portion has a single structure including a first resin layer having predetermined magnetic characteristics owing to mixture of magnetic powder, the second core portion has a laminate structure including each of second, third and fourth resin layers, the second resin layer has predetermined magnetic characteristics owing to the mixture of the magnetic powder, and a third resin layer and a fourth resin layer have no magnetic powder mixed therein and are formed to sandwich the second resin layer therebetween from the top side and the bottom side.

The antenna according to the present invention has following effects due to the above-described configuration. According to the present invention, an adverse influence by a mitigation loss caused by the magnetic powder can be reduced, and thus the gain of the antenna can be improved. Also the antenna can be miniaturized owing to the interaction of the permittivity of the dielectric layer and the magnetic permeability of the magnetic powder.

### BRIEF DESCRIPTION OF THE DRAWINGS

FIG. 1 is a perspective view showing an antenna of a first embodiment according to the present invention.

FIGS. 2(a) and 2(b) are views showing the front and back surfaces of the antenna shown in FIG. 1, wherein FIG. 2(a) is a view showing the front surface whereas FIG. 2(b) is a view showing the back surface.

FIG. 3 is a perspective view showing a core structure of the antenna according to the present invention.

FIG. 4 is a graph illustrating characteristics of a permittivity (∈) of a first resin layer 1a having 50 (wt %) of Ni—Zn—Cu soft ferrite powder having an average particle diameter of about 0.5 (μm) mixed therein.

FIG. 5 is a graph illustrating characteristics of a gain (dBi) with respect to a frequency (MHz) of the antenna having the configuration shown in FIG. 1.

FIG. 6 is a graph illustrating characteristics of a permittivity (∈) of a first resin layer 1a having 50 (wt %) of Mn—Zn—Cu soft ferrite powder having an average particle diameter of about 1.2 (μm) mixed therein.

FIG. 7 is a perspective view showing a core structure of an antenna of a second embodiment according to the present invention.

FIG. 8 is a perspective view showing a core structure of an antenna of a third embodiment according to the present invention.

FIG. 9 is a perspective view showing a core structure of an antenna of a fourth embodiment according to the present invention.

FIG. 10 is a perspective view showing a core structure of an antenna of a fifth embodiment according to the present invention.

### DETAILED DESCRIPTION OF THE INVENTION

An antenna according to the present invention includes: a resin core; a coil conductor helically winding around the center portion of the core; a beginning pattern formed at a beginning position of the coil conductor on the right side of the core; an ending pattern formed at an end position of the coil on the left side of the core; and various terminals.

Here, the core is formed to have the outside shape of a rectangular thick plate. In the core, a first resin layer having magnetic powder mixed therein is formed as a middle layer, and second and third resin layers, which have no magnetic powder mixed therein are formed to sandwich the first resin layer. Accordingly, the core has a laminate structure consisting of each of the first, second and third resin layers.

Here, it is preferable to use a polymer resin for each of the resin layers and to use Ni—Zn—Cu or Mn—Zn—Cu soft ferrite powder as the magnetic powder.

The coil conductor includes: a plurality of first conductor patterns formed on the front surface of the core; a plurality of second conductor patterns formed on the back surface of the core; metallic conductors provided in a plurality of through holes penetrating from the front surface to the back surface of the core, respectively; a beginning pattern formed around the right end on the back surface of the core; and an ending pattern formed around the left end on the back surface of the core. The coil conductor is formed into one conductive line beginning from the beginning pattern, helically winding around the center portion of the core, and ending at the ending pattern by a mutual connection of the first conductor patterns, the second conductor patterns, and the metallic conductors.

The various terminals are three terminals, that is, a control terminal, an earth terminal, and an input/output terminal, all of which are formed on the back surface of the core. The control terminal is formed around the right end of the core and is electrically connected to the beginning pattern. Both of the earth terminal and the input/output terminal are formed around the left end of the core, the earth terminal is electrically connected to the ending pattern, and the input/output terminal is electrically connected to a predetermined position of the second conductor patterns.

In the antenna having the above-described configuration, a thickness of each of the first, second, and third resin layers may be varied depending on a current distribution pattern appearing on the coil conductor or a resonant mode signal which is desired to be suppressed. The thickness may be gradually varied linearly or in a stepwise manner.

In the antenna according to the present invention, there may be provided a first core portion having a single layer structure, and second and third core portions, each having a laminate structure, between the right and left ends of the core in order to further enhance a gain depending on the current distribution pattern appearing on the coil conductor. Here, the first core portion is constituted only of a first resin layer having predetermined magnetic characteristics owing to the mixture of the magnetic powder. In the meantime, in the second core portion, a second resin layer having the magnetic powder mixed therein is formed as a middle layer, and a third resin layer and a fourth resin layer, which have no magnetic powder mixed therein are formed to sandwich the second resin layer therebetween. Accordingly, the second core portion has a laminate structure consisting of each of the second, third, and fourth resin layers.

In addition, the third core portion is formed between the first core portion and the second core portion. In the third core portion, similarly to the second portion, a fifth resin layer having magnetic powder mixed therein is formed as a middle layer, and a sixth resin layer and a seventh resin layer, which have no magnetic powder mixed therein are formed to sandwich the fifth layer therebetween. Accordingly, the third core portion has a laminate structure consisting of each of the fifth, sixth, and seventh resin layers. Here, the fifth resin layer is formed thicker than the second resin layer whereas the sixth resin layer and seventh resin layer are formed thinner than the third resin layer and the fourth resin layer.

Each of the embodiments of the antenna according to the present invention will be described below.

### FIRST EMBODIMENT

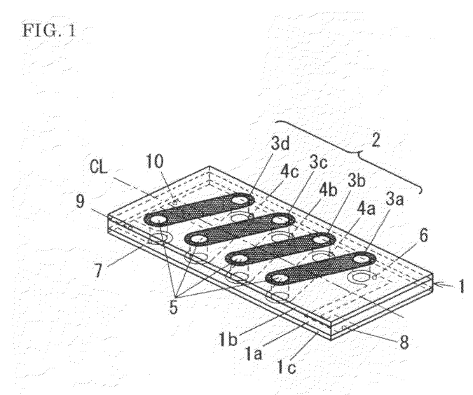

FIGS. 1 to 3 show a structure of an antenna of a first embodiment according to the present invention.

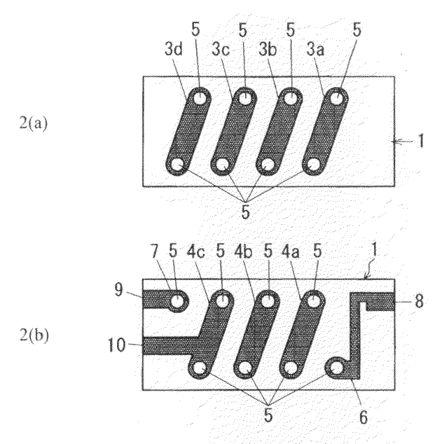

FIG. 1 is a perspective view showing an antenna; FIGS. 2(a) and 2(b) are views showing the front surface and back surface of the antenna shown in FIG. 1, wherein FIG. 2(a) is a view showing the front surface whereas FIG. 2(b) is a view showing the back surface.

Reference numeral 1 denotes a core having a laminate structure, in which a first resin layer 1a having magnetic powder mixed therein is formed as a middle layer, and a second resin layer 1b and a third resin layer 1c, which have no magnetic powder mixed therein are formed to sandwich the first resin layer 1a therebetween. The core 1 will be described in detail later.

Reference numeral 2 denotes a coil conductor constituting the following conductor pattern. On the front surface of the core 1 are formed four conductor patterns 3a to 3d as first conductor patterns. Each of the conductor patterns 3a to 3d is not parallel to right and left sides of the core 1, but is formed in straight line inclined diagonally upward right, as shown in FIG. 2(a). In the meantime, on the back surface of the core 1 are formed other three conductor patterns 4a to 4c as second conductor patterns. Each of the conductor patterns 4a to 4c also is not parallel to the right and left sides of the core 1, but is formed in straight line inclined diagonally upward right, as shown in FIG. 2(b).

Here, when the conductor patterns 4a to 4c are viewed in a perspective manner from the front surface, each of the conductor patterns 4a to 4c are formed in straight line inclined diagonally upward left, as shown in FIG. 1, and each of the conductor patterns 3a to 3d and each of the conductor patterns 4a to 4c are arranged to overlap at their ends in the perspective view. At positions where the conductor patterns 3a to 3d and the conductor patterns 4a to 4c respectively overlap in the perspective view, through holes filled with metallic conductors 5 respectively are formed.

As shown in FIG. 2(b), a beginning pattern 6 is formed on the right of the conductor patterns 4a to 4c on the back surface of the core 1, and is electrically connected to the rightmost conductor pattern 3a shown in FIG. 2(a) via one of the metallic conductors 5. Similarly, as shown in FIG. 2(b), an ending pattern 7 is formed on the left of the conductor patterns 4a to 4c, and is electrically connected to the leftmost conductor pattern 3d shown in FIG. 2(a) via another metallic conductor 5.

The mutual connection of the conductor patterns 3a to 3d and 4a to 4c and the metallic conductors 5 forms one conductive line obtained by sequentially connecting the conductor pattern 3a as the beginning, the metallic conductor 5, the conductor pattern 4a, the metallic conductor 5, the conductor pattern 3b, the metallic conductor 5, the conductor pattern 4b, . . . and the conductor pattern 3d as the end. The conductive line substantially forms the coil conductor 2 which helically winds around a center line CL of the core 1, that is, a center portion.

As shown in FIG. 2(b), at different positions around the left end on the back surface of the core 1 are formed an earth terminal 9 and an input/output terminal 10. The earth terminal 9 is formed at the position near the ending pattern 7, and electrically connected to the ending pattern 7, whereas the input/output terminal 10 is electrically connected to the leftmost conductor pattern 4c.

Also, a control terminal 8 is formed around the right end on the back surface of the core 1. The control terminal 8 is formed at a position near the beginning pattern 6 and electrically connected directly to the beginning pattern 6.

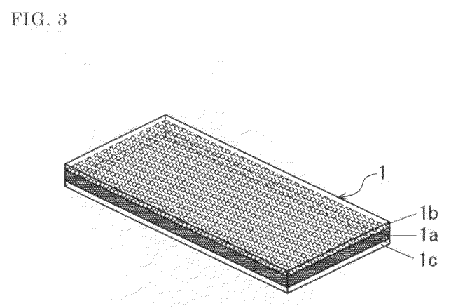

The antenna of the first embodiment according to the present invention utilizes the core 1 having a laminate structure, in which the first resin layer 1a is arranged at the middle and the second resin layer 1b and the third resin layer 1c are formed to sandwich the first resin layer 1a therebetween, as shown in FIG. 3. Here, the thickness of the first resin layer 1a is set to 0.6 (mm), for example, whereas the thickness of each of the second resin layer 1b and the third resin layer 1c is set to 0.3 (mm). Each of the first, second, and third resin layers 1a, 1b, and 1c is made of a polymer resin having a permittivity (∈) of about 2, and only the first resin layer 1a thereamong has magnetic powder mixed therein.

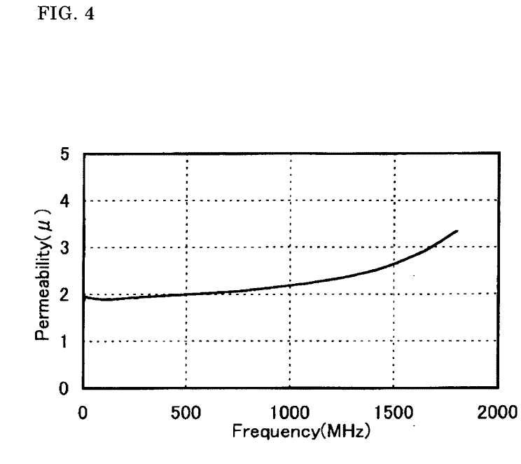

The magnetic powder mixed into the first resin layer 1a is specifically Ni—Zn—Cu soft ferrite powder having an average particle diameter of about 0.5 (μm) measured by a laser diffraction scattering method. The first resin layer 1a having the magnetic powder mixed therein in an amount of 50 (wt %) maintains a stable magnetic permeability with respect to frequencies in a relatively wide range, as illustrated in FIG. 4. Specifically; the first resin layer 1a has a permittivity (∈) of about 2 with respect to a frequency band assigned for FM radio broadcasting (76 to 90 MHz) to a frequency band assigned for digital terrestrial broadcasting (470 to 770 MHz).

Incidentally, since the Ni—Zn—Cu soft ferrite is an insulating oxide having a relatively high permittivity (∈), the first resin layer 1a has a permittivity (∈) of about 5 owing to the mixture of the magnetic powder.

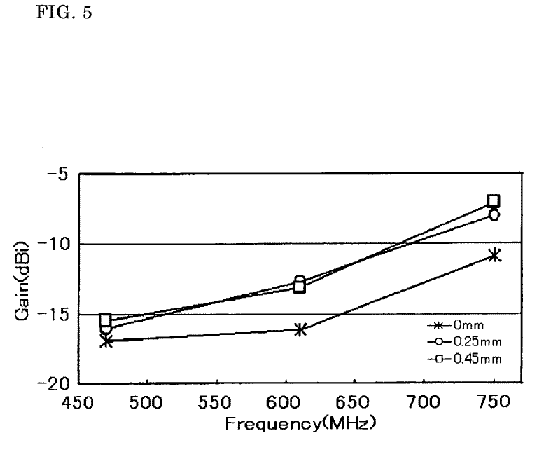

FIG. 5 illustrates characteristics of a gain (dBi) with respect to a frequency (MHz) of the antenna having the configuration shown in FIG. 1, in which the first resin layer 1a has 50 (wt %) of Ni—Zn—Cu soft ferrite powder having an average particle diameter of about 0.5 (μm) mixed therein. The legends respectively illustrate cases where the thickness of each of the first, second, and third resin layers 1a, 1b, and 1c is varied while keeping the thickness of the core 1 constantly at 1.2 (mm). In the figure, respective characteristics in the cases where the thickness of each of the second resin layer 1b and the third resin layer 1c is varied to 0 (mm), 0.25 (mm), and 0.45 (mm) are distinguishably illustrated with symbols.

As is seen from FIG. 5, the core 1 provided with the second resin layer 1b and the third resin layer 1c having no magnetic powder mixed therein on both surfaces of the first resin layer 1a having the magnetic powder mixed therein exhibits a gain higher than that of the core 1 of the single resin layer having the magnetic powder mixed therein. As a consequence, in order to attain an antenna of a certain gain, the shape of the antenna having the laminate structure can be smaller than the antenna having the single layer structure. Here, when the thickness of each of the second resin layer 1b and the third resin layer 1c becomes 0.25 (mm) or greater, the gain hardly varies. This shows that the thickness of each of the second resin layer 1b and the third resin layer 1c need not be increased.

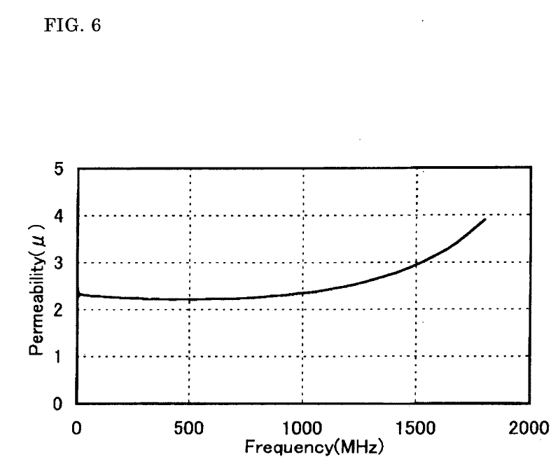

Incidentally, the magnetic powder mixed into the first resin layer 1a may be magnetic powder other than Ni—Zn—Cu soft ferrite. For example, in the case where Mn—Zn—Cu soft ferrite powder having an average particle diameter of about 1.2 (μm) measured by a laser diffraction scattering method is used as the magnetic powder, the first resin layer 1a having the magnetic powder mixed therein in an amount of 50 (wt %) exhibits a permittivity illustrated in FIG. 6. Specifically, the first resin layer 1a has a permittivity (∈) of about 2.3 with respect to the frequency band assigned for the FM radio broadcasting (76 to 90 MHz) to the frequency band assigned for the digital terrestrial television broadcasting (470 to 770 MHz). Also in the case of using such first resin layer 1a, the antenna exhibits substantially the same characteristics of the gain as those illustrated in FIG. 5, although specific values of gains are slightly different.

In addition, the first resin layer 1a may be made of soft ferrite having a composition or a particle diameter other than that exemplified above. It has been found that the composition without Cu, such as Ni—Zn or Mn—Zn soft ferrite may be used, and that the particle diameter may range from 0.05 to 10.0 (μm). Further, the first resin layer 1a may be made of a soft magnetic material such as Fe—Si—B metallic amorphous material other than the soft ferrite as long as it can maintain a stable magnetic permeability with respect to frequencies in a relatively wide range.

### SECOND EMBODIMENT

Next, an antenna of a second embodiment according to the present invention will be described below.

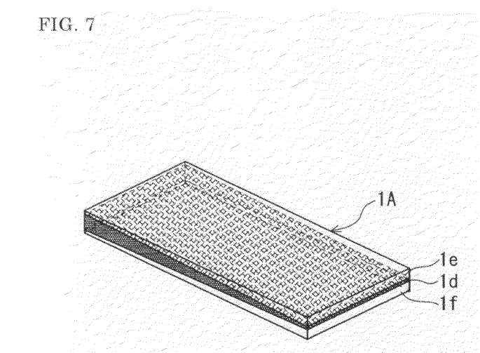

FIG. 7 shows a core structure used in an antenna of the second embodiment according to the present invention.

A core 1A shown in FIG. 7 has a constant thickness as a whole; however the thickness of each of first, second, and third resin layers 1d, 1e, and 1f is linearly varied. Specifically, at a right side of the core 1A, the first resin layer 1d is thinly formed while the second and third resin layers 1e and 1f are thickly formed, whereas at a left side of the core 1A, the first resin layer 1d is thickly formed while the second and third resin layers 1e and 1f are thinly formed. The thickness of each of the first, second, and third resin layers 1d, 1e, and 1f is gradually varied from right to left of the core 1A in linear manner.

### THIRD EMBODIMENT

Next, an antenna of a third embodiment according to the present invention will be described below.

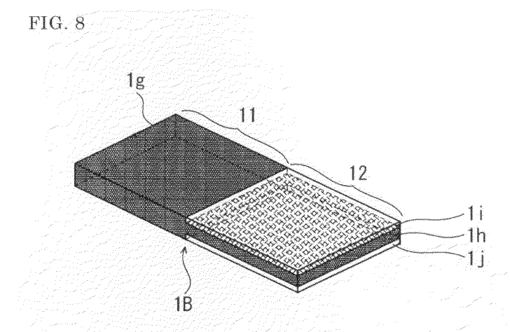

FIG. 8 shows a core structure used in an antenna of the third embodiment according to the present invention.

A core 1B shown in FIG. 8 includes: a first core portion 11 of a single layer structure including a resin layer 1g having magnetic powder mixed therein only at a left half; and the second core portion 12 of a laminate structure including a first resin layer 1h having the magnetic powder mixed therein as a middle layer at a right half, and a second resin layer 1i and a third resin layer 1j, both of which are made of a resin only to sandwich the first resin layer 1h therebetween in a thickness direction.

### FOURTH EMBODIMENT

Next, an antenna of a fourth embodiment according to the present invention will be described below.

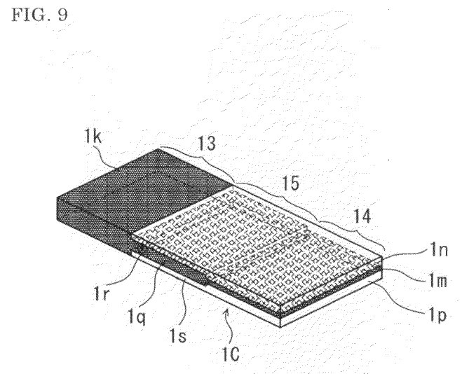

FIG. 9 shows a core structure used in an antenna of the fourth embodiment according to the present invention.

A core 1C shown in FIG. 9 includes: a first core portion 13 of a single layer structure including a resin layer 1k having magnetic powder mixed therein at a left wing portion; a second core portion 14 of a laminate structure including a first resin layer 1m having the magnetic powder mixed therein as a middle layer at a right wing portion, and a second resin layer in and a third resin layer 1p, both of which are made of a resin only to sandwich the first resin layer 1m therebetween in a thickness direction; and a third core portion 15 of a laminate structure including a first resin layer 1q having the magnetic powder mixed therein as a middle layer at a middle portion, and a second resin layer 1r and a third resin layer is, both of which are made of a resin only to sandwich the first resin layer 1q therebetween in the thickness direction.

Here, the resin layer 1q having the magnetic powder mixed therein at the middle portion is formed thicker than the resin layer 1m having the magnetic powder mixed therein at the right wing. As a consequence, when the core 1C is viewed as a whole, the thickness of the resin layer 1m having the magnetic powder mixed therein is virtually varied in stepwise from right to left.

In the above-described first embodiment, when the coil conductor 2 is formed on front surface of the core 1 and power is supplied to the coil conductor 2 from the beginning pattern 6 on the right of the core 1, and the ending pattern 7 on the left of the core 1 is opened, as shown in FIGS. 1 and 2 so as to achieve a helical antenna, a resonant mode in a low frequency band can be suppressed by configuring the core 1 as shown in FIGS. 7, 8, and 9. To the contrary, when power is supplied to the coil conductor 2 from the ending pattern 7 on the left of the core 1, and the beginning pattern 6 on the right of the core 1 is opened so as to achieve a helical antenna, a resonant mode in a high frequency band can be suppressed.

In addition, in the above-described second to fourth embodiments, in the case where an antenna of a ¼ wavelength is configured by using the cores 1A, 1B, and 1C having the structures shown in FIGS. 7, 8, and 9, when the power is supplied to the conductor pattern formed on the front surface (or back surface) of the first core portion 11 or 13, radiation or reception due to a resonant mode other than that of the ¼ wavelength can be suppressed. This is because the current distribution generated in the coil conductor 2 is varied depending on the frequency, and therefore, the gain is decreased more at a portion that does not include a resin layer made of the resin only without magnetic powder mixed therein.

### FIFTH EMBODIMENT

Next, an antenna of a fifth embodiment according to the present invention will be described below.

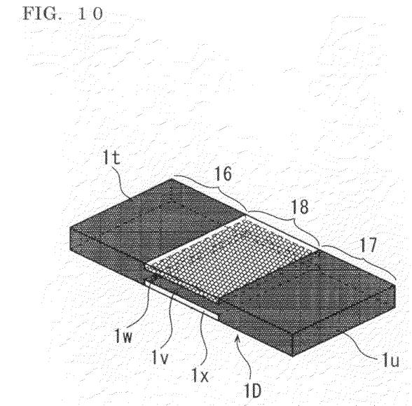

FIG. 10 shows a core structure used in an antenna of the fifth embodiment according to the present invention.

A core 1D shown in FIG. 10 includes: first and second core portions 16 and 17 of a single layer structure including resin layers 1t and 1u having magnetic powder mixed therein at left and right wing portions, respectively; and a third core portion 18 of a laminate structure including a resin layer 1v having the magnetic powder mixed therein as a middle layer in a thickness direction at a middle portion, and resin layers 1w and 1x, both of which are made of a resin only to sandwich the resin layer 1v therebetween in the thickness direction.

A current distribution on an antenna of a ½ wavelength, generally shows that a large current is generated at the middle of the antenna. When the resin layer 1v made of the resin only without magnetic powder mixed therein is formed at the middle portion as shown in FIG. 10, a high gain can be obtained with respect to a resonant mode of a ½ wavelength, which makes the current in the third core portion 18 large. However, with respect to other resonant mode, which makes the current in the remaining portion other than the middle portion large, the gain is decreased and suppressed due to the first and second core portions 16 and 17 respectively consisting of the resin layers having the magnetic powder mixed therein at the left and right wing portions. As a consequence, it is possible to configure a small antenna having high gain and little unnecessary radiation.

There is provided an antenna whose outside shape can be miniaturized while maintaining a gain at a desired level with respect to a radio wave of frequencies in a wide range. The antenna is applicable to mobile terminal device which singly receives radio waves of frequencies in a wide range including FM radio broadcasting and television broadcasting from VHF band to UHF band, or the frequencies in wide range further including mobile radio communications in high frequencies of a UHF band, for example.

1. An antenna comprising a core, a coil conductor helically wound around a center portion of the core, and terminals for electrically connecting the coil conductor to an outside circuit, wherein the core comprises a first resin layer comprising a mixture of a resin and a magnetic powder and having predetermined magnetic characteristics owing to the magnetic powder and a second resin layer and a third resin layer having no magnetic powder mixed therein and sandwiching the first resin layer therebetween from a top side and a bottom side of the core.

2. The antenna according to claim 1, wherein the coil conductor comprises: a plurality of first conductor patterns formed on a first surface of the core including a front surface of the second resin layer; a plurality of second conductor patterns formed on a second surface of the core including a front surface of the third resin layer; a plurality of metallic conductors, each of which electrically connects an end of a predetermined one of the first conductor patterns to an end of a predetermined one of the second conductor patterns; a beginning pattern formed around a first end on the second surface and electrically connected to the first conductor pattern positioned closest to the first end via the metallic conductor; and an ending pattern formed around a second end on the second surface and electrically connected to the first conductor pattern positioned closest to the second end via the metallic conductor.

3. The antenna according to claim 2, wherein the terminals comprise: a control terminal formed around the first end on the second surface; an earth terminal formed around the second end on the second surface and electrically connected to the ending pattern; and an input/output terminal formed around the second end on the surface of the third resin layer and electrically connected to a predetermined one of the second conductor patterns.

4. The antenna according to claim 2, wherein each of the metallic conductors is a metallic conductor inside of a through hole penetrating from the first surface to the second surface.

5. The antenna according to claim 2, wherein the first resin layer has a thickness gradually decreasing from the first end to the second end.

6. The antenna according to claim 5, wherein each of the second resin layer and the third resin layer has a thickness gradually increasing from the first end to the second end.

7. The antenna according to claim 2, wherein the first resin layer has a thickness gradually increasing from the first end toward the second end.

8. The antenna according to claim 7, wherein each of the second resin layer and the third resin layer has a thickness gradually decreasing from the first end toward the second end.

9. The antenna according to any one of claims 5 to 8, wherein the gradual variation of the thickness of the first resin layer is linear.

10. The antenna according to claim 6 or claim 8, wherein the gradual variation of the thickness of each of the second resin layer and the third resin layer is linear.

11. The antenna according to any one of claims 5 to 8, wherein the gradual variation of the thickness of the first resin layer is stepwise.

12. The antenna according to claim 6 or claim 8, wherein the gradual variation of the thickness of each of the second resin layer and the third resin layer is stepwise.

13. The antenna according to claim 1, wherein each of the first to third resin layers comprises a polymer resin.

14. The antenna according to claim 1, wherein the magnetic powder in the first resin layer comprises any one of Mn—Zn soft ferrite, Ni—Zn soft ferrite, Mn—Zn—Cu soft ferrite, and Ni—Zn—Cu soft ferrite.

15. The antenna according to claim 1, wherein a proportion of the magnetic powder in the first resin layer is 30 wt % to 70 wt %.

16. An antenna comprising a resin core, a coil conductor helically wound around a center portion of the core, and terminals for electrically connecting the coil conductor to an outside circuit, wherein the core comprises at least a first core portion and a second core portion formed between a first end and a second end of the core, the first core portion has a unitary structure comprised of a first resin layer comprising a mixture of a resin and a magnetic powder and having predetermined magnetic characteristics owing to the magnetic powder therein, the second core portion has a laminate structure including each of second, third and fourth resin layers, the second layer is comprised of a mixture of a resin and a magnetic powder and has predetermined magnetic characteristics owing to of the magnetic powder therein, and the third resin layer and the fourth resin layer have no magnetic powder mixed therein and sandwich the second resin layer therebetween from a top side and a bottom side of the core.

17. The antenna according to claim 16, wherein the core further comprises a third core portion formed between the first core portion and the second core portion, the third core portion has a laminate structure including each of fifth, sixth, and seventh resin layers, the fifth resin layer comprises a mixture of a resin and a magnetic powder and has predetermined magnetic characteristics owing to the magnetic powder and is thicker than the second resin layer, the sixth resin layer and the seventh resin layer have no magnetic powder mixed therein and sandwich the fifth resin layer therebetween from the top side and the bottom side of the core, and each of the sixth resin layer and the seventh resin layer is thinner than the third resin layer and the fourth resin layer.

18. The antenna according to claim 16, wherein each of the first to fourth resin layers comprises a polymer resin.

19. The antenna according to claim 17, wherein each of the fifth to seventh resin layers comprises a polymer resin.

20. The antenna according to any one of claims 16 to 19, 23 and 24, wherein the magnetic powder in the first resin layer and the second resin layer comprises any one of Mn—Zn soft ferrite, Ni—Zn soft ferrite, Mn—Zn—Cu soft ferrite, and Ni—Zn—Cu soft ferrite.

21. The antenna according to any one of claims 17, 19, 23 and 24, wherein the magnetic powder mixed into the fifth resin layer includes any one of Mn—Zn soft ferrite, Ni—Zn soft ferrite, Mn—Zn—Cu soft ferrite, and Ni—Zn—Cu soft ferrite.

22. The antenna according to any one of claims 16 to 19, wherein the proportion of the magnetic powder in each of the resin layers containing the magnetic powder is 30 wt % to 70 wt %.

23. The antenna according to claim 17, wherein each of the first to fourth resin layers comprises a polymer resin.

24. The antenna according to claim 23, wherein each of the fifth to seventh resin layers comprises a polymer resin.

25. The antenna according to claim 20 or 21, wherein the proportion of the magnetic powder in each of the resin layers containing the magnetic powder is 30 wt % to 70 wt %.
